(19) United States
(12) Patent Application Publication
(10) Pub. No.: US 2018/0369953 A1
(43) Pub. Date: Dec. 27, 2018

(54) ULTRASONIC BONDING METHOD, ULTRASONIC BONDING JIG, AND BONDING STRUCTURE

(71) Applicant: NIPPON MEKTRON, LTD., Tokyo (JP)

(72) Inventors: Hiroshi MIYASHIRO, Tokyo (JP); Shuhei KOYANO, Tokyo (JP); Yoichi SURUGA, Tokyo (JP)

(73) Assignee: NIPPON MEKTRON, LTD., Tokyo (JP)

(21) Appl. No.: 15/923,466

(22) Filed: Mar. 16, 2018

(30) Foreign Application Priority Data
Jun. 22, 2017 (JP) 2017-121923

(51) Int. Cl. B23K 20/10

(52) U.S. Cl. CPC B23K 20/106

(57) ABSTRACT

An ultrasonic bonding method includes: stacking a metal plate and a base material; pressing the metal plate to the base material by an ultrasonic bonding jig; forming a plurality of recessed portions, a flat portion among recessed portions, and an annular flat portion on the metal plate by the ultrasonic bonding jig, the flat portion among recessed portions being disposed among the plurality of recessed portions, the annular flat portion surrounding the plurality of recessed portions; and vibrating the ultrasonic bonding jig while the ultrasonic bonding jig presses the metal plate.

### CROSS-REFERENCE TO RELATED APPLICATION

This application claims priority from Japanese Patent Application No. 2017-121923 filed with the Japan Patent Office on Jun. 22, 2017, the entire content of which is hereby incorporated by reference.

### BACKGROUND

### 1. Technical Field

The present disclosure relates to an ultrasonic bonding method, an ultrasonic bonding jig, and a bonding structure.

### 2. Description of the Related Art

Typically, ultrasonic bonding is performed by vibration of an electrode laminated body pressed to between a chip with a plurality of protrusions and an anvil. Protrusions disposed on an outermost periphery among the plurality of protrusions are, for example, chamfered protrusions formed by performing chamfering such that the protrusions have an arc having a radius R meeting R≥A/6 with an external dimension in the one direction defined as A on a contour line. This restrains a break of the electrode laminated body caused by ultrasonic welding (for example, see WO 2013/105361 A (the sixth page)).

Additionally, there has been known an ultrasonic welding bonding method using a torsion sonotrode (for example, see JP-T-2013-538128 (the third page, FIGS. 1 to 3)). In an ultrasonic welding treatment process, a torsion sonotrode contact surface has a flat stop surface extending in an actually perpendicular direction with respect to a torsion axis. Press-fitting protrusion portions protruding from this stop surface into a component combines the contact surface with the component. Furthermore, the flat stop surface settles an approach depth of the protrusion portions to the component. Therefore, the ultrasonic welding has a constant strength.

### SUMMARY

An ultrasonic bonding method includes: stacking a metal plate and a base material; pressing the metal plate to the base material by an ultrasonic bonding jig; forming a plurality of recessed portions, a flat portion among recessed portions, and an annular flat portion on the metal plate by the ultrasonic bonding jig, the flat portion among recessed portions being disposed among the plurality of recessed portions, the annular flat portion surrounding the plurality of recessed portions; and vibrating the ultrasonic bonding jig while the ultrasonic bonding jig presses the metal plate.

### BRIEF DESCRIPTION OF THE DRAWINGS

FIG. 1 illustrates a principle diagram of ultrasonic bonding according to an embodiment;

FIG. 2 is a side view illustrating a distal end portion of a head used in a first embodiment:

FIG. 3A is a bottom view of the distal end portion of the head used in the first embodiment and is a view on arrow A in FIG. 2. FIG. 3B illustrates a B-B cross-sectional surface of FIG. 3A, and FIG. 3C illustrates a C-C cross-sectional surface of FIG. 3A;

FIGS. 4A to 4C illustrate ultrasonic bonding according to the first embodiment, FIG. 4A illustrates the ultrasonic bonding of a copper foil with a busbar, FIG. 4B illustrates a bonding portion after the ultrasonic bonding, and FIG. 4C is a view viewed from an arrow D in FIG. 4B;

FIG. 5 describes ultrasonic bonding of a flexible circuit board with a busbar according to a second embodiment; and

FIG. 6 illustrates a cross-sectional surface taken along E-E in FIG. 5.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A technique in WO 2013/105361 A performs ultrasonic bonding on a laminated body. For bonding of single-layer members having a large difference in thickness together, it is difficult for this technique to sufficiently restrain cracks at a thin member.

Additionally, a technique in JP-T-2013-538128 relates to an ultrasonic welding treatment process using a torsion sonotrode. An application of this technique to a thin member possibly results in a deformation and a crack of the member.

One object of the present disclosure is to provide an ultrasonic bonding method, an ultrasonic bonding jig, and a bonding structure that can restrain cracks when members having a large difference in thickness are bonded together.

An ultrasonic bonding method according to an aspect of the present disclosure (this bonding method) includes: stacking a metal plate and a base material; pressing the metal plate to the base material by an ultrasonic bonding jig; forming a plurality of recessed portions, a flat portion among recessed portions, and an annular flat portion on the metal plate by the ultrasonic bonding jig, the flat portion among recessed portions being disposed among the plurality of recessed portions, the annular flat portion surrounding the plurality of recessed portions; and vibrating the ultrasonic bonding jig while the ultrasonic bonding jig presses the metal plate.

According to this bonding method, since the plurality of recessed portions does not penetrate the metal plate, this restrains lowering strength of the metal plate. Furthermore, the flat portion among recessed portions and the annular flat portion restrict a relative vibration between the ultrasonic bonding jig and the metal plate during ultrasonic bonding. Consequently, the cracks at the metal plate can be restrained.

This bonding method may include further forming an annular inclined portion on the metal plate by the ultrasonic bonding jig. The annular inclined portion surrounds the annular flat portion. The annular inclined portion gradually increases in thickness radially outside. According to this, the annular inclined portion, which surrounds the annular flat portion, reduces strains at boundaries between pressed sites by the ultrasonic bonding jig and non-pressed sites on the metal plate. Therefore, the cracks at the metal plate can be restrained.

In this bonding method, the forming the recessed portions may include forming the recessed portions such that the recessed portions have approximately rectangular cross-sectional surfaces. The vibrating the ultrasonic bonding jig may include vibrating the ultrasonic bonding jig along a direction perpendicular to one side of the approximately rectangular cross-sectional surfaces of the recessed portions. This allows excellent transmission of ultrasonic vibration from protrusions to the metal plate and the efficient ultrasonic bonding of the metal plate with the base material.

In this bonding method, the metal plate may be a thin single-layer metal plate, and the base material may be a single-layer metal plate thicker than the metal plate. This ensures the ultrasonic bonding of the single-layer metal plates having different thicknesses together.

In this bonding method, the metal plate may be a flexible circuit board, and the base material may be a busbar. This ensures the ultrasonic bonding of the extremely thin flexible circuit board with the busbar far thicker than the flexible circuit board.

An ultrasonic bonding jig according to an aspect of the present disclosure (this bonding jig) includes: a base; and a distal end portion. The distal end portion includes: a plurality of protrusions; a flat portion among protrusions formed among the plurality of protrusions; and an annular flat portion that surrounds the plurality of protrusions.

In this bonding jig, the plurality of protrusions preferably has a height so as not to penetrate the metal plate. This restrains lowering the strength of the metal plate. Furthermore, the ultrasonic bonding is performed while the flat portion among protrusions and the annular flat portion surrounding the plurality of protrusions press the metal plate. Consequently, the cracks at the metal plate can be restrained.

This bonding jig may further include an annular escaping portion. The annular escaping portion surrounds the annular flat portion. The annular escaping portion is inclined to be away from the annular flat portion. According to this, the annular escaping portion reduces the strains at the boundaries between the pressed sites by this bonding jig and the non-pressed sites on the metal plate. Therefore, the cracks at the metal plate can be restrained.

A bonding structure according to an aspect of the present disclosure (this bonding structure) includes a bonding portion of a metal plate and a base material. The bonding portion includes a plurality of recessed portions, a flat portion among recessed portions, and an annular flat portion on the metal plate, the flat portion among recessed portions being disposed among the plurality of recessed portions, the annular flat portion surrounding the plurality of recessed portions.

According to this bonding structure, since the plurality of recessed portions does not penetrate the metal plate, this restrains lowering the strength of the metal plate. Furthermore, the ultrasonic bonding is performed while the flat portion among recessed portions and the annular flat portion, which surrounds the plurality of recessed portions, press the metal plate. Consequently, the cracks at the metal plate can be restrained.

In this bonding structure, the bonding portion may further include an annular inclined portion on the metal plate. The annular inclined portion surrounds the annular flat portion. The annular inclined portion has a thickness that gradually increases radially outside. According to this, the annular inclined portion, which surrounds the annular flat portion and gradually increases in thickness, reinforces the bonding portion. Therefore, the cracks at the metal plate can be restrained.

In this bonding structure, the metal plate may be a thin single-layer metal plate, and the base material may be a single-layer metal plate thicker than the metal plate. This ensures bonding the single-layer metal plates having different thicknesses together.

In this bonding structure, the metal plate may be a flexible circuit board, and the base material may be a busbar. This ensures bonding of the extremely thin flexible circuit board with the busbar far thicker than the flexible circuit board.

The following describes embodiments of the ultrasonic bonding method, the ultrasonic bonding jig, and the bonding structure according to the present disclosure.

### First Embodiment

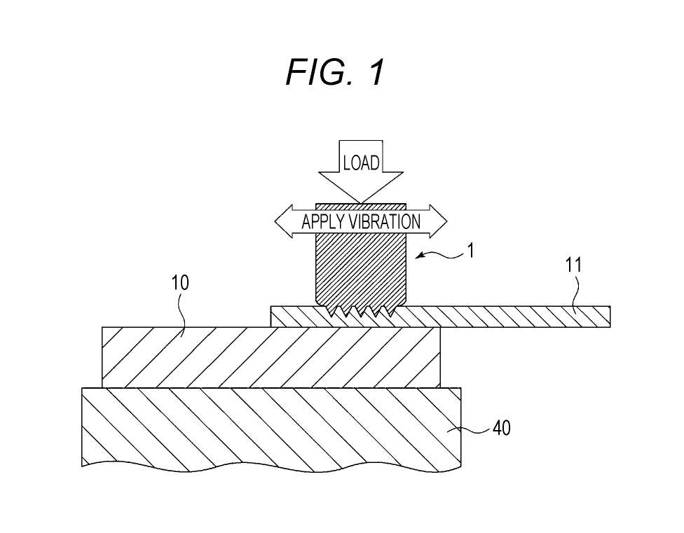

The following describes an ultrasonic bonding method, an ultrasonic bonding jig, and a bonding structure according to the first embodiment with reference to FIGS. 1 to 4C.

FIG. 1 is a principle diagram of ultrasonic bonding. A copper foil 11 and a busbar 10 are stacked and are placed to be fixed on a support table 40. The copper foil 11 is pressed to the busbar 10 by a head 1. In this state, ultrasonic vibration is horizontally performed on the head 1 at a predetermined frequency. Thus, the pressing force and the ultrasonic vibration by the head 1 remove an oxide and another dirt on metal surfaces from contact surfaces of the copper foil 11 and the busbar 10. Furthermore, metal atoms are bonded together on the above-described contact surfaces by friction heating caused by the pressing force and the ultrasonic vibration. The copper foil 11 is equivalent to one example of a metal plate according to the present disclosure and may be a thin single-layer metal plate. The busbar 10 is equivalent to one example of a base material according to the present disclosure and may be a single-layer metal plate thicker than the metal plate.

The following describes the head 1 used for the ultrasonic bonding of the present embodiment. The head 1 is equivalent to one example of the ultrasonic bonding jig according to the present disclosure.

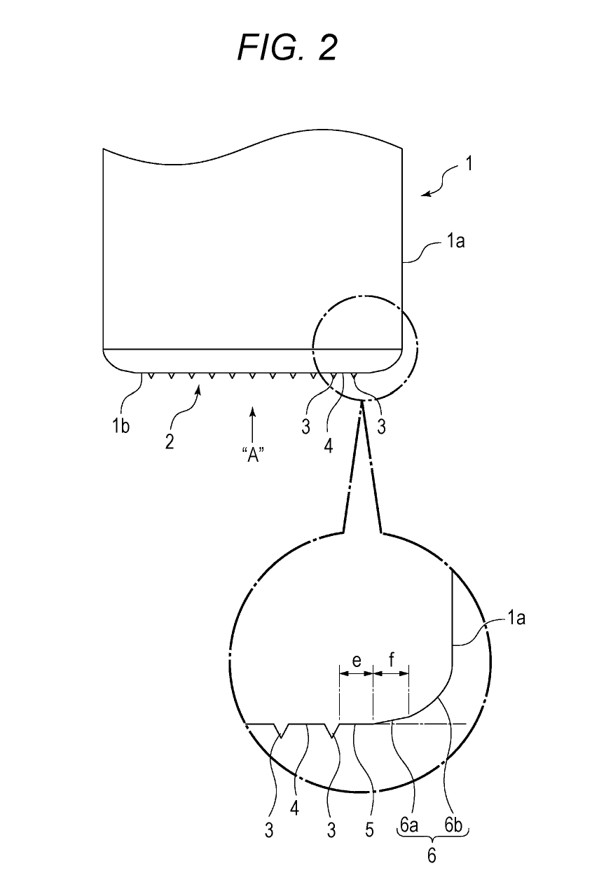

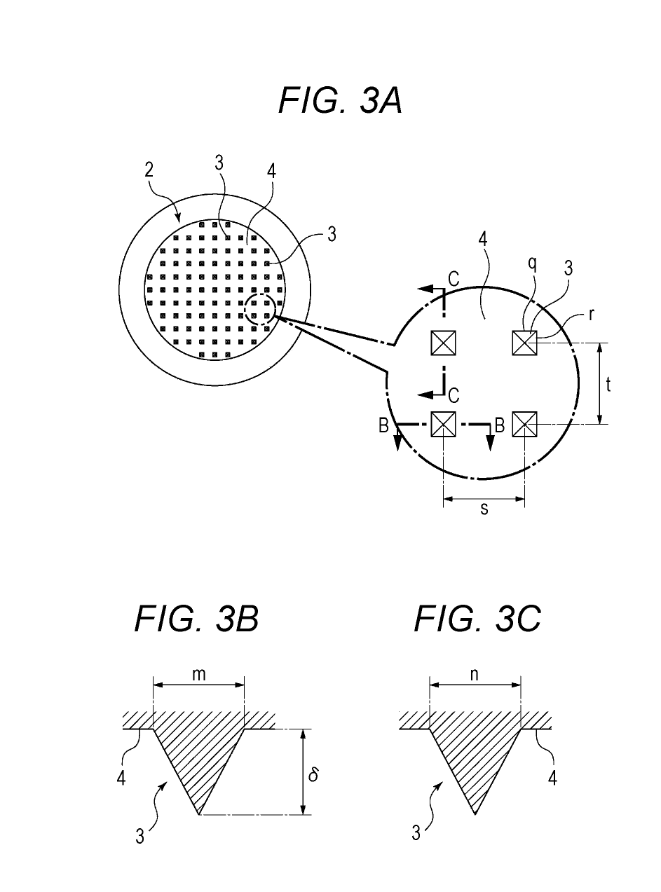

As illustrated in FIG. 2 and FIGS. 3A to 3C, the head 1 has a base 1a and a distal end portion 1b. This distal end portion 1b includes a protrusion group 2, a flat portion among protrusions 4, an annular flat portion 5, and an annular escaping portion 6. The protrusion group 2 has a plurality of protrusion portions 3 arranged like islands. The flat portion among protrusions 4 has flat surfaces disposed between the adjacent protrusion portions 3. The annular flat portion 5 is disposed across the whole circumference outside the protrusion group 2. The annular flat portion 5 has a flat surface with a radial width e and without a protrusion. The annular escaping portion 6 is formed across the whole circumference outside the annular flat portion 5,

As illustrated in FIGS. 3A to 3C. the protrusion portion 3 has a quadrangular pyramid shape having a rectangular bottom surface (a cross-sectional surface) with bottom sides q and r and a height δ. The protrusion portions 3 can provide a sufficient sandwiching force in the thickness direction to the copper foil 11 and the busbar 10 together with the support table 40 and has rigidity by which the protrusion portions 3 themselves are less likely to deform by the force caused by ultrasonic vibration applied from the head 1. A length m of the bottom side q and a length n and the height δ of the bottom side r are determined according to materials of the copper foil 11 and the busbar 10. The protrusion portion 3 only need to have the shape meeting performance (conditions) demanded for the protrusion portion 3. For example, the length m of the bottom side q and the length n of the bottom side r may be configured to have dimensions identical to one another or configured to have dimensions different from one another according to the conditions. Additionally, the height can also be configured to be longer than or shorter than the length m of the bottom side q and the length n of the bottom side r or may be configured to meet m=n=δ according to the conditions.

The protrusion portion 3 has the height configured to be smaller than the thickness of the copper foil 11. This restrains the protrusion portions 3 penetrating the copper foil 11 when the copper foil 11 and the busbar 10 are sandwiched between the protrusion group 2 and the support table 40. Accordingly, the protrusion group 2 does not penetrate the copper foil 11, restraining low strength of the copper foil 11. When the copper foil 11 and the busbar 10 are sandwiched between the protrusion group 2 and the support table 40, the protrusion group 2 can provide a high contact force to the contact surfaces between the copper foil 11 and the busbar Consequently, the ultrasonic vibration allows efficiently removing an oxide and another dirt from the metal surface and mutual bonding of the metal atoms.

However, even when the height of the protrusion portions 3 is configured to be smaller than the thickness of the copper foil 11, relative vibration between the protrusion portions 3 and the copper foil 11 possibly cracks the copper foil 11. The flat portion among protrusions 4 is disposed between the adjacent protrusion portions 3 to restrain the cracks. When the copper foil 11 and the busbar 10 are sandwiched between the protrusion group 2 and the support table 40, the flat portion among protrusions 4 contacts the copper foil 11 and act as a stopper. Accordingly, since the relative vibration between the protrusion portions 3 and the copper foil 11 is restrained, the cracks at the copper foil 11 can be restrained.

The respective protrusion portions 3 included in the protrusion group 2, for example, are configured such that the direction of the bottom side q or r becomes perpendicular to (approximately perpendicular to) the direction of the ultrasonic vibration. This ensures excellent transmission of the force by the ultrasonic vibration applied from the head 1 to the copper foil 11 and the busbar 10. Furthermore, this ensures restraining the cracks at the copper foil 11. The plurality of protrusion portions 3 is arrayed and arranged into a grid pattern having a longitudinal direction interval t and a lateral direction interval s. The longitudinal direction interval t and the lateral direction interval s are determined considering the size of the copper foil 11, the material of the busbar 10, the magnitude of the force that the copper foil 11 and the busbar 10 are sandwiched, and the like. Accordingly, the longitudinal direction interval t and the lateral direction interval s may be configured to have sizes identical to one another or may be configured to have sizes different from one another. In FIG. 3A, the plurality of protrusion portions 3 is disposed into the grid pattern. Instead of this, the plurality of protrusion portions 3 may be disposed into a houndstooth pattern.

As illustrated in FIG. 2 and FIGS. 3A to 3C, the annular flat portion 5 is disposed outside the protrusion group 2. The annular flat portion 5 is disposed across the whole circumference outside the protrusion group 2. The annular flat portion 5 has the flat surface with the radial width e and without a protrusion. The annular flat portion 5 may be formed to be at a height level identical to the flat portion among protrusions 4. When the copper foil 11 is sandwiched between the protrusion group 2 and the support table 40, the annular flat portion 5 can collaborate with the flat portion among protrusions 4 to restrain a relative displacement between the protrusion group 2 and the copper foil 11. That is, the flat portion among protrusions 4 can press the copper foil 11 between the adjacent protrusion portions 3 and restrain the relative displacement at these parts. Furthermore, the annular flat portion 5 can restrain the relative displacement between the protrusion portions 3 disposed at the outermost periphery of the protrusion group 2 and the copper foil 11. That is, the flat portion among protrusions 4 and the annular flat portion 5 can press the copper foil 11 across the entire surface of the distal end portion 1b of the head 1. This ensures efficiently restraining the relative displacement between the head 1 and the copper foil 11. Consequently, the cracks at the copper foil 11 can be restrained.

The following describes the annular escaping portion 6. When the copper foil 11 and the busbar 10 are sandwiched between the protrusion group 2 and the support table 40, concave deformation slightly occurs at the part of the copper foil 11 pressed by the protrusion group 2. This “concave deformation” is released at the outside of the annular flat portion 5. That is, the shape (the surface shape) of the copper foil 11 sharply changes at the proximity of the annular flat portion 5. This possibly causes the crack in the copper foil 11. Therefore, as illustrated in FIG. 2, the annular escaping portion 6 is disposed to reduce the sharp deformation of the copper foil 11 at the outer peripheral edge of the protrusion group 2.

The annular escaping portion 6 includes an inclined portion 6a formed so as to be smoothly continuous with the annular flat portion 5 and a rounded portion 6b. The inclined portion 6a is a surface inclined by around 2° to 5° with respect to the annular flat portion 5. The rounded portion 6b is a curved surface smoothly continuous with the inclined portion 6a. The annular escaping portion 6 with such shape reduces the sharp deformation of the copper foil 11 at the outer peripheral edge of the annular flat portion 5, restraining the cracks at the copper foil 11. The annular escaping portion 6 includes the inclined portion 6a and the rounded portion 6b. Instead of this, the annular escaping portion 6 may be configured by only the inclined portion 6a or only the rounded portion 6b. The annular escaping portion 6 may be configured so as to surround the annular flat portion 5 and be inclined to a side surface of the base 1a. The annular escaping portion 6 may be configured to so as to surround the annular flat portion 5 and be inclined so as to be away from the annular flat portion 5.

The following describes steps of the ultrasonic bonding with reference to FIGS. 1 to 4C. First, the copper foil 11 and the busbar 10 are arranged between the support table 40 and the head 1 (an arranging step). Next, the copper foil 11 and the busbar 10 are sandwiched between the head 1 and the support table 40 in the thickness direction (a sandwiching step). Subsequently, the ultrasonic vibration is performed on the head 1. Accordingly, the pressing force and the ultrasonic vibration from the head 1 act on the contact surfaces between the copper foil 11 and the busbar 10 via the protrusion group 2. Consequently, an oxide and another dirt are removed from the surfaces of the copper foil 11 and the busbar 10. Furthermore, friction heating caused by the pressing force and the ultrasonic vibration performs the bonding between metal atoms (a bonding step), and then the ultrasonic bonding is completed.

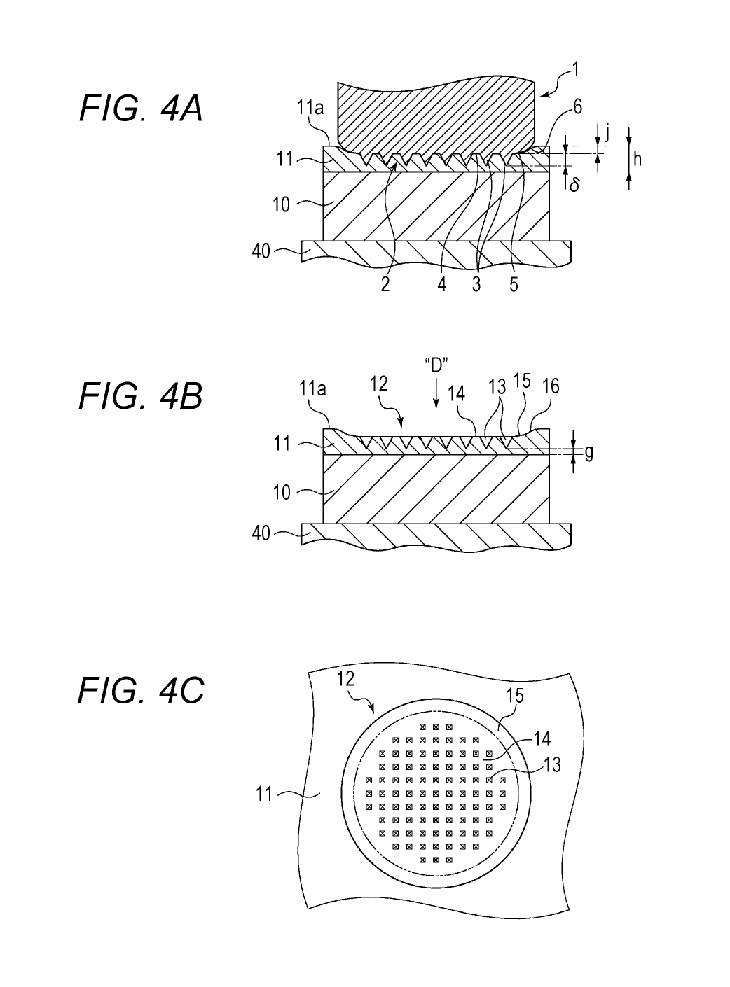

Here, the following further describes the sandwiching step. As illustrated in FIG. 4A, the height δ of the protrusion portion 3 is configured to be smaller than a thickness h of the copper foil 11. Therefore, when the copper foil 11 is sandwiched between the protrusion group 2 and the support table 40, the protrusion portions 3 do not penetrate the copper foil 11. FIG. 4B illustrates a state where the bonding of the copper foil 11 with the busbar 10 is completed. As illustrated in FIG. 4B, distal ends of recessed portions 13 formed on the copper foil 11 have non-penetrating portions g. This restrains lowering the strength of the copper foil 11. Accordingly, when the copper foil 11 is sandwiched between the protrusion group 2 and the support table 40, the high contact force is provided to the contact surfaces between the copper foil 11 and the busbar 10. Consequently, the ultrasonic vibration allows efficiently removing an oxide and another dirt from the metal surfaces and bonding the metal atoms together.

The recessed portions 13 may be formed so as to have an approximately rectangular cross-sectional surface on the copper foil 11 by the head 1. Furthermore, the head 1 may be vibrated (the ultrasonic vibration) along a direction perpendicular (approximately perpendicular) to one side of the rectangular cross-sectional surfaces of the recessed portions 13.

Additionally, the flat portion among protrusions 4 and the annular flat portion 5 are formed to be at the identical height level. When the copper foil 11 and the busbar 10 are sandwiched between the protrusion group 2 and the support table 40, the flat portion among protrusions 4 can collaborate with the annular flat portion 5 and restrain the relative displacement between the protrusion group 2 and the copper foil 11. The flat portion among protrusions 4 mainly restrains the relative displacement between the protrusion group 2 (the protrusion portions 3) and the copper foil 11 between the protrusion portions 3. The annular flat portion 5 mainly restrains the relative displacement between the protrusion portions 3 disposed at the outermost periphery of the protrusion group 2 and the copper foil 11. This ensures efficiently restraining the relative displacement between the protrusion portions 3 and the copper foil 11 across the entire surface of the protrusion group 2. Consequently, the cracks at the copper foil 11 can be restrained.

Further, as illustrated in FIG. 4A, when the copper foil 11 and the busbar 10 are sandwiched between the protrusion group 2 and the support table 40, the surface of the copper foil 11 sinks by a depth j. At this time, at the proximity of the annular flat portion 5, the crack is likely to occur at the copper foil 11 at boundaries between the sunk parts and parts not sunk on a surface 11a of the copper foil 11. Therefore, the annular escaping portion 6 is disposed at the outer peripheral edge of the annular flat portion 5. This annular escaping portion 6 allows reducing the sharp deformation of the copper foil 11 at the outer peripheral edge of the annular flat portion 5. Consequently, the cracks at the copper foil 11 can be restrained.

As illustrated in FIGS. 4A to 4C, a bonding portion 12 is formed on the surface of the copper foil 11 pressed by the head 1. The bonding portion 12 is slightly sunk with respect to the surface 11a of the copper foil 11 The head 1 forms a recessed portion group including the plurality of recessed portions 13 arranged (formed) like the islands, a flat portion among recessed portions 14, an annular flat portion 15, and an annular inclined portion 16 on the bonding portion 12 (the copper foil 11). The flat portion among recessed portions 14 is formed (disposed) between the adjacent recessed portions 13. The annular flat portion 15 surrounds the outside of the recessed portion group across the whole circumference. Recessed portions are not formed at the annular flat portion 15. The annular inclined portion 16 surrounds the outside of the annular flat portion 15 across the whole circumference. The annular inclined portion 16 has a thickness, for example, gradually increasing in thickness radially outside. The bonding portion 12 having such shape ensures restraining the cracks at the copper foil 11 and also ensures the excellent ultrasonic bonding of the copper foil 11 with the busbar 10.

### Second Embodiment

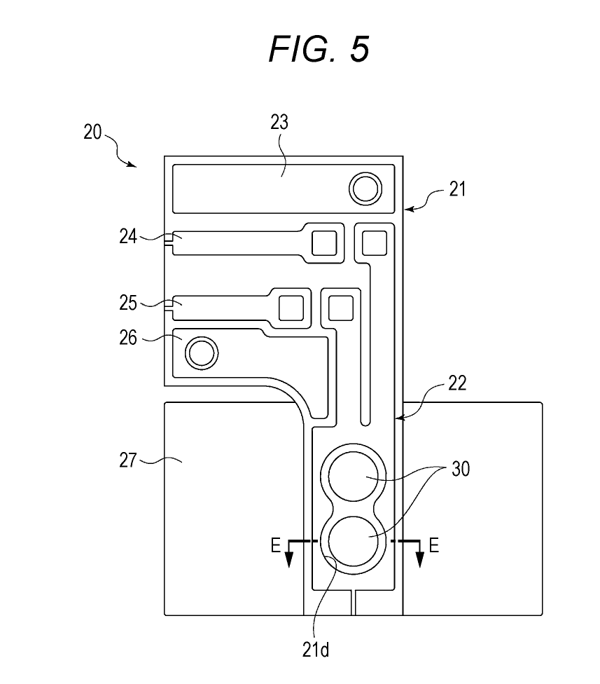

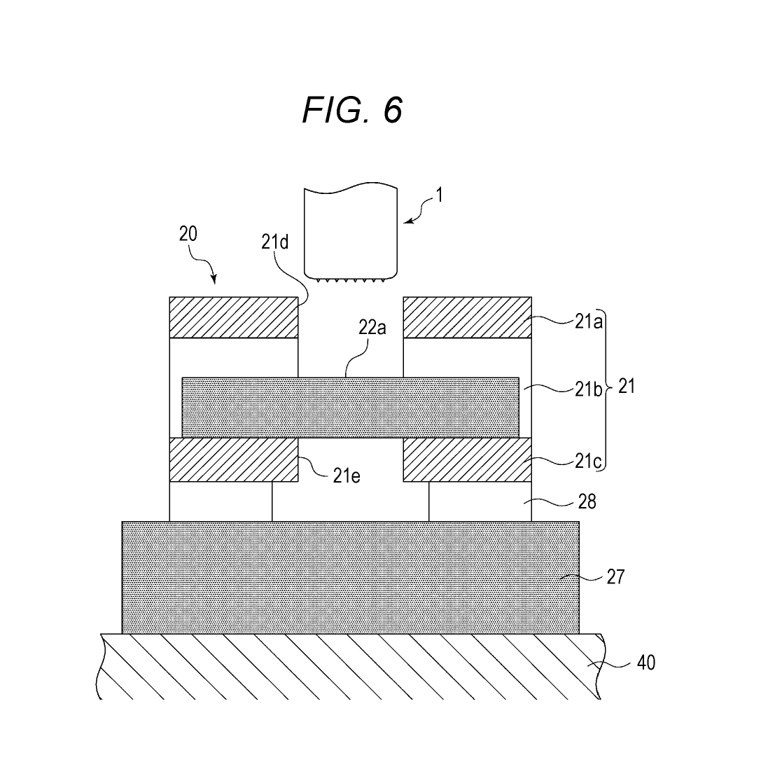

The following describes an ultrasonic bonding method, an ultrasonic bonding jig, and a bonding structure according to the second embodiment with reference to FIGS. 5 and 6. Like reference numerals designate identical configurations to the first embodiment, and therefore such configurations will not be further elaborated here.

The ultrasonic bonding method and the bonding structure of the second embodiment bond a flexible circuit board 20 and a busbar 27 together by formation of bonding portions 30 through ultrasonic bonding. FIG. 5 illustrates the two bonding portions 30. However, the number of bonding portions 30 is not limited to the two locations. For example, the bonding portions 30 may be disposed at one, three, or four or more locations according to a magnitude of a current flowing through the flexible circuit board 20. The flexible circuit board 20 is equivalent to one example of the metal plate according to the present disclosure or a thin metal plate. The busbar 27 is equivalent to one example of the base material according to the present disclosure.

As illustrated in FIGS. 5 and 6, the flexible circuit board 20 includes copper foil portions 22, 23, 24, 25, and 26 constituting an electric circuit and a base film 21 that insulates these copper foil portions 22, 23, 24, 25, and 26. The copper foil portions 22, 23, 24, 25, and 26 are equivalent to one example of the metal foil according to the present disclosure. The flexible circuit board 20 has an electric circuit pattern that has already been formed on the base film 21. Therefore, the use of the flexible circuit board 20 allows labor-saving of wiring work. Since the flexible circuit board 20 is extremely thin and can be freely bent, the flexible circuit board 20 can be arranged at a slight gap in the device. Thus, the flexible circuit board 20 can be freely bent for use. Hence, external force acts on the bonding portions 30 from various directions.

The base film 21 of the flexible circuit board 20 is, for example, made of polyimide with a thickness around 25 μm. The base film 21 includes a base material 21c and a cover material 21a. The copper foil portions 23, 24, 25, and 26 of the flexible circuit board 20 are formed as follows. First, a copper foil with a thickness around 35 μm is adhered on the base material 21c with adhesive 21b. An application of a printing technique to this copper foil forms the copper foil portions 22. 23, 24, 25, and 26, which constitute the desired electric circuit pattern, on the base material 21c. Furthermore, as necessary, the cover material 21a is adhered on the copper foil portions 22, 23, 24, 25, and 26. This cover material 21a insulates the copper foil portions 22, 23, 24, 25, and 26 constituting the electric circuit and protects and reinforces the extremely thin copper foil portions 22, 23, 24, 25, and 26. The cover material 21a can be omitted.

The following describes an example of the ultrasonic bonding between the copper foil portion 22 and the busbar 27. As illustrated in FIG. 6, the busbar 27 is a single-layer metal plate such as a copper plate with a thickness around 1.5 mm. Meanwhile, the copper foil is a single-layer thin plate metal with a thickness around 35 μm. That is, the thicknesses of the two members are significantly different. Typically, stably bonding a large amount of two metal members having significantly different thicknesses by automated lines was difficult.

As illustrated in FIG. 6, the base material 21c, which covers the copper foil portion 22, and the cover material 21a of the flexible circuit board 20 has openings 21d and 21e. Consequently, a copper foil exposed portion 22a (an exposed part of the copper foil portion 22) is formed in the flexible circuit board 20. Excluding the copper foil exposed portion 22a, the base material 21c of the flexible circuit board 20 and the busbar 27 are fixed with an adhesive portion 28. The head 1 is brought into contact with the copper foil exposed portion 22a of the flexible circuit board 20. The copper foil exposed portion 22a and the busbar 27 are sandwiched between the head 1 and the support table 40. Performing the ultrasonic vibration on the head 1 in this state forms the bonding portions 30 at the copper foil exposed portion 22a and the busbar 27, which are sandwiched between the head 1 and the support table 40. These bonding portions 30 electrically bond the copper foil portion 22 of the flexible circuit board 20 and the busbar 27 together.

Here, the following further describes a sandwiching step where the copper foil exposed portion 22a and the busbar 27 are sandwiched between the head 1 and the support table 40. As illustrated in FIG. 6, the base material 21c and the adhesive portion 28 form a clearance between the copper foil exposed portion 22a of the copper foil portion 22 and the busbar 27. Therefore, the sandwiching step significantly deforms the thin copper foil portion 22 and large stress is applied to the thin copper foil portion 22. Hence, a crack is likely to occur in the copper foil portion 22 (the copper foil exposed portion 22a). Meanwhile, the adhesive portion 28 is disposed between the base material 21c of the flexible circuit board 20 and the busbar 27. Hence, the adhesive portion 28 absorbs the large stress occurred in the copper foil portion 22 in the sandwiching step. Consequently, an influence of strain in the sandwiching step can be lowered. Additionally, the peripheral areas of the ultrasonic bonding portions (the bonding portions 30) are fixed with the adhesive portion 28. Accordingly, even after welding, external force acting on the bonding portions 30 can be dispersed by the adhesive portion 28. Consequently, a load applied to the bonding portions 30 can be lowered.

With the present embodiment, the bonding portions 30 formed by the head 1 includes in the copper foil exposed portion 22a the recessed portion group, which includes the plurality of recessed portions formed like the islands, the flat portion among recessed portions, which are formed between the adjacent recessed portions, the annular flat portion, which surrounds the outside of the recessed portion group across the whole circumference and does not have a recessed portion, and the annular inclined portion, which surrounds the outside of the annular flat portion across the whole circumference. Accordingly, the cracks at the copper foil portion 22 can be restrained. Furthermore, the adhesive portion 28 between the base material 21c of the flexible circuit board 20 and the busbar 27 absorb the strain in the sandwiching step. Therefore, the cracks at the copper foil portion 22 can be efficiently restrained.

In the above, the embodiments of the present disclosure have been described with the drawings. The specific configuration of the technique in the present disclosure is not limited to these embodiments. The above-described embodiments may be changed, and other configurations or steps may be added to the above-described embodiments, in a range without departing from the gist of the technique in the present disclosure.

For example, with the first and second embodiments, the protrusion portions 3 formed at the head 1 have the quadrangular pyramid shape. However, the shape of the protrusion portion 3 is not limited to this, and may also be a polygonal pyramid shape such as a triangular pyramid shape and a pentagonal pyramid shape, a truncated pyramid shape such as a truncated triangular pyramid and a truncated square pyramid, a cone shape, a rectangular parallelepiped shape, or the like.

The embodiments of the present disclosure may also be the following first to fifth ultrasonic bonding methods, first and second ultrasonic bonding jigs, and first to fourth bonding structures.

The first ultrasonic bonding method is an ultrasonic bonding method that presses a head on which a plurality of protrusions is formed to a metal plate while vibrating the head to bond the metal plate and a base material together. The ultrasonic bonding method forms a plurality of recessed portions that does not penetrate the metal plate, a flat portion among recessed portions among the plurality of recessed portions, and an annular flat portion that surrounds the plurality of recessed portions.

In the second ultrasonic bonding method according to the first ultrasonic bonding method, an annular inclined portion is further formed. The annular inclined portion surrounds the annular flat portion, and the metal plate of the annular inclined portion has a thickness gradually increasing in thickness radially outside.

In the third ultrasonic bonding method according to the first or the second ultrasonic bonding method, the recessed portions are formed into approximately rectangular shapes. The head is vibrated in a direction perpendicular to one side of the recessed portions.

In the fourth ultrasonic bonding method according to any one of the first to the third ultrasonic bonding methods, the metal plate is a thin single-layer metal plate. The base material is a single-layer metal plate thicker than the metal plate.

In the fifth ultrasonic bonding method according to any one of the first to the fourth ultrasonic bonding methods, the metal plate is a flexible circuit board. The base material is a busbar.

The first ultrasonic bonding jig is a jig for ultrasonic bonding of a metal plate with a base material. The ultrasonic bonding jig includes a plurality of protrusions having a height not penetrating the metal plate, a flat portion among protrusions formed among the plurality of protrusions, and an annular flat portion surrounding the plurality of protrusions.

The second ultrasonic bonding jig according to the first ultrasonic bonding jig further includes an annular escaping portion. The annular escaping portion surrounds the annular flat portion. The annular escaping portion is inclined openably with respect to the annular flat portion.

The first bonding structure is a bonding structure that bonds a metal plate and a base material together. The bonding structure includes a plurality of recessed portions having a depth so as not to penetrate the metal plate, a flat portion among recessed portions disposed among the plurality of recessed portions, and an annular flat portion surrounding the plurality of recessed portions.

The second bonding structure according to the first bonding structure further includes an annular inclined portion that surrounds the annular flat portion, and the metal plate of the annular inclined portion has a thickness that gradually increases in thickness.

In the third bonding structure according to the first or the second bonding structure, the metal plate is a thin single-layer metal plate, and the base material is a single-layer metal plate thicker than the metal plate.

In the fourth bonding structure according to the first to the third bonding structures, the metal plate is a flexible circuit board, and the base material is a busbar.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An ultrasonic bonding method comprising:
stacking a metal plate and a base material;
pressing the metal plate to the base material by an ultrasonic bonding jig;
forming a plurality of recessed portions, a flat portion among recessed portions, and an annular flat portion on the metal plate by the ultrasonic bonding jig, the flat portion among recessed portions being disposed among the plurality of recessed portions, the annular flat portion surrounding the plurality of recessed portions; and
vibrating the ultrasonic bonding jig while the ultrasonic bonding jig presses the metal plate.

2. The ultrasonic bonding method according to claim 1, further comprising
further forming an annular inclined portion on the metal plate by the ultrasonic bonding jig, the annular inclined portion surrounding the annular flat portion, annular inclined portion gradually increasing in thickness radially outside.

3. The ultrasonic bonding method according to claim 1, wherein
the forming the recessed portions includes forming the recessed portions such that the recessed portions have approximately rectangular cross-sectional surfaces, and
the vibrating the ultrasonic bonding jig includes vibrating the ultrasonic bonding jig along a direction perpendicular to one side of the approximately rectangular cross-sectional surfaces of the recessed portions.

4. The ultrasonic bonding method according to claim 1, wherein
the metal plate is a thin single-layer metal plate, and the base material is a single-layer metal plate thicker than the metal plate.

5. The ultrasonic bonding method according to claim 1, wherein
the metal plate is a flexible circuit board, the base material being a busbar.

6. An ultrasonic bonding jig comprising:
a base; and
a distal end portion, wherein
the distal end portion includes:
a plurality of protrusions;
a flat portion among protrusions formed among the plurality of protrusions; and
an annular flat portion that surrounds the plurality of protrusions.

7. The ultrasonic bonding jig according to claim 6, further comprising
an annular escaping portion surrounding the annular flat portion, the annular escaping portion being inclined to be away from the annular flat portion.

8. A bonding structure comprising
a bonding portion of a metal plate and a base material, wherein
the bonding portion includes a plurality of recessed portions, a flat portion among recessed portions, and an annular flat portion on the metal plate, the flat portion among recessed portions being disposed among the plurality of recessed portions, the annular flat portion surrounding the plurality of recessed portions.

9. The bonding structure according to claim 8, wherein
the bonding portion further includes an annular inclined portion on the metal plate, the annular inclined portion surrounding the annular flat portion, the annular inclined portion having a thickness that gradually increases radially outside.

10. The bonding structure according to claim 8, wherein
the metal plate is a thin single-layer metal plate, and the base material is a single-layer metal plate thicker than the metal plate.

11. The bonding structure according to claim 8, wherein
the metal plate is a flexible circuit board, and the base material is a busbar.
